(19) United States
(12) Patent Application Publication
(10) Pub. No.: US 2003/0065569 A1
(43) Pub. Date: Apr. 3, 2003

(54) Method and apparatus for coordinating transaction data for a plurality of point-of-sale terminals

(76) Inventors: Aaron Danis, Colorado Springs, CO (US); Randy Crupper, Palmer Lake, CO (US)

Correspondence Address: MINTZ, LEVIN, COHN, FERRIS, GLOVSKY, AND POPEO, P.C., ONE FINANCIAL CENTER, BOSTON, MA, 02111, US

(21) Appl. No.: 10/235,517

(22) Filed: Sep. 4, 2002

Related U.S. Application Data
(60) Provisional application No. 60/317,373, filed on Sep. 4, 2001.

(51) Int. Cl. G06F 17/60

(52) U.S. Cl. 705/21

(57) ABSTRACT

A system and method for wirelessly processing transactions from a plurality of point-of-sale terminals using a wireless transaction system, the system including a wireless data network for communicating data between a remote device and a server on a computer network, a plurality of point-of-sale terminals, a communications hub in communication with each of the plurality of point of sale terminals and a communications device in communication with the communications hub. The communication device includes a transceiver for communicating data to and from the server via the wireless network for at least two point of sale terminals. The method includes scanning by the communications device via the communication hub each point-of-sale terminal for a request to send transaction data, receiving a request to send transaction data from a first point of sale terminal, suspending scanning of the remainder of the plurality of point of sale terminals, asserting a clearance for sending the transaction data from the first point of sale terminal to the transceiver, sending the transaction data from the first point of sale terminal to the transceiver via the communications hub, receiving the transaction data by the transceiver, verifying that the transaction data is complete, forwarding the transaction data from the transceiver to the server via the wireless data network for obtaining transaction authorization, dropping the clearance to send indication and continuing scanning of the point of sale terminals for a next request to send transaction data.

### PRIORITY CLAIM

The present invention claims benefit under 35 U.S.C. §119(e) of U.S. Provisional Patent Application No. 60/317,373, filed Sep. 4, 2001, the entire disclosure of which are herein incorporated by reference.

### BACKGROUND OF THE INVENTION

1. Field of the Invention

The present invention relates to the use of wireless data communication and more particularly to a device which enables other devices not connected to land based telephone lines to access a computer network via a wireless data network. Moreover, the present invention also enables “live” point-of-sale electronic transactions and point-of-usage services for a plurality of point-of-sale terminals.

2. Background of the Invention

Wireless data communications have expanded and opened up the possibility for a variety of services which were formerly not available or inconvenient. Service stations, delivery services, food services, vending machines, mobile sales, retailers, entertainment, and transportation services are can be greatly enhanced because of wireless technology.

Wireless devices in communication with a wireless network are “live”, i.e., available for instant communication with the network. Such real-time connections are especially convenient for monitoring and tracking, including, for example, tracking vehicles and the like. Wireless communications also make possible point of sale transactions using credit, debit, EBT and other types of payment cards, devices, biometrics, wireless phones and other identification elements. This is convenient for both remote point of sale devices, and other point of sale devices in which a land based telephone line is not immediately available.

One skilled in the art will appreciate that the present application refers to “point-of-sale” devices to be defined as any device (mobile or fixed) in which a transaction is conducted for the purchase of a product or service. In addition, the present application defines “point-of-usage” as any device (mobile or fixed) in which information is collected.

Wireless Data Communications

Wireless data communications are processed over wireless data networks. These wireless data networks currently include Cellular Digital Data Packet Data (CDPD), the Motient network, General Packet Radio Service (GPRS), CDMA (Code Division Multiple Access) and TDMA (time-division multiple access) as examples. CDPD and the Motient network are two of the most widely used systems, with each transmitting and receiving data in digital packet form.

Currently, wireless devices (mobile or fixed) communicate with a wireless network with a radio frequency (RF) transceiver or modem. An RF modem takes the data and converts it to radio frequencies for the particular wireless network to be received by a base station. Modems are generally network specific, i.e., a modem designed for use with a CDPD network cannot be used on the Motient network.

CDPD networks operate by sending digital packet data over the same frequency spectrum as analog voice in the existing AMPS analog network (Advanced Mobile Phone Service), but with different modulation in the air interface. Analog cellular channels that are not being used for voice calls are used to transmit data. However, since voice calls have priority over data transmission, another channel must be found to transmit data when a voice transmission occurs over the channel (dedicated channels).

A CDPD modem configures data packets according to the popular TCP/IP Internet protocol, enabling Internet, Intranet or other networks (whether public or private) to work transparently over the CDPD network. Thus, devices configured to operate with the Internet work seamlessly with a CDPD network. TCP/IP packet data is transformed into a modulated waveform with the modem for transmission onto a physical RF channel.

Although MOTIENT networks operate using digital packet data, they operate with a different proprietary protocol than that of a CDPD network. Specifically, Native Control Language protocol is used as a link layer protocol between the client application on the point-of-sale/usage device and the RF modem.

In order for a remote device to access a wireless network, the data must be configured in a form acceptable for transmission on the particular network (e.g., TCP/IP protocol) and also must be connected to a modem designed to operate with the network. If the remote device is a personal computer, or a device connected to a personal computer, configuring the data for a particular network is done by using available software code which allows a remote device to communicate with the modem and the wireless network.

However, providing wireless transceiver for each point of sale device at a retail establishment to communicate with a wireless data network, is cost prohibitive. Accordingly, there exists a need for a cost effective system/device/method for communicating transactional data for one or more point of sale devices wirelessly.

### SUMMARY OF THE INVENTION

Accordingly, the present invention (hereinafter referred to as “the Concentrator”) addresses the concerns noted above. The Concentrator easily facilitates credit transactions and the transfer of data on particular wireless networks.

The present invention allows a group of wired point-of-sale terminals to obtain wireless credit approvals as opposed to one-to-one solution where one device makes one wired terminal wireless so that a separate wireless modem device is required to convert each terminal. Moreover, the present invention improves response time from the standard dial response time of 12 to 18 seconds to 4 to 6 seconds and less.

The present invention may also be manufactured terminal independent, in that it may be used with any type of point-of-sale terminal, and may also be used as a platform for a Local Area Network and wireless WAN, thereby eliminating cables that connect the point-of-sale terminals to the Concentrator.

The present invention also provides methods of authorization and/or payment for goods and services using credit, debit, EBT or other card types. Moreover, the present invention may be used with other types of identification methods such as biometrics. Accordingly, hereinafter all such payment and authorization methods and devices will be referred as “Credit”.

In one aspect of the present invention, a device having hardware and software code allows a point-of-sale/usage device with a serial output device to communicate with a CDPD wireless network via a CDPD modem.

In another aspect of the present invention, a device having hardware and software code allows a point-of-sale/usage device with a serial output device to communicate with the MOTIENT wireless network via a DataTAC modem.

Not withstanding the above two aspects, the Concentrator may be modified to provide data processing over any RF network or other wireless medium.

In still another aspect of the present invention, a device having hardware and software code allows a magnetic card reading device to input identification data for use of a point-of-sale/usage device for transmission over a wireless network. Such identification data may be Credit card information for payment of a sale at the point-of-sale/usage device for the purchase of goods and/or services.

Accordingly, in one aspect of the present invention, a system for processing transactions for a plurality of point-of-sale terminals wirelessly includes a plurality of point-of-sale terminals, a communications hub in communication with each of the plurality of point of sale terminals and a communications device in communication with the communications hub, the communications device for communicating data to and from a wireless network for at least two point of sale terminals.

In another aspect of the present invention, a system for processing transactions for a plurality of point-of-sale terminals wirelessly includes a wireless data network for communicating data between a remote device and a server on a computer network, a plurality of point-of-sale terminals, a communications hub in communication with each of the plurality of point of sale terminals and a wireless data network transceiver in communication with the communications hub. The transceiver for communicating data to and from the server via the wireless network for at least two point of sale terminals.

In another aspect of the present invention, a system for wirelessly processing transactions from a plurality of point-of-sale terminals includes a plurality of point-of-sale terminals each having a first communication port, a communications hub having a corresponding second communication port for connection with each first communication port of the plurality of point of sale terminals, a control port, a data port, and a status indicator for each of the second communication ports and a communications device. The communications device includes a controller, a wireless data network transceiver, a control port for connection with the control port of the hub, a data port for connection with the data port of the hub, a power supply and an antenna. The transceiver communicates transaction data over a wireless network to a server provided on a computer network for at least two point of sale terminals.

In yet another aspect of the present invention, each of the above system aspects of the invention may be used with a method for wirelessly processing transactions from a plurality of point-of-sale terminals, the method including scanning by the communication hub each point-of-sale terminal for a request to send transaction data, receiving a request to send transaction data from a first point of sale terminal, suspending scanning of the remainder of the plurality of point of sale terminals, asserting a clearance for sending the transaction data from the first point of sale terminal to the transceiver, sending the transaction data from the first point of sale terminal to the transceiver via the communications hub, receiving the transaction data by the transceiver, verifying that the transaction data is complete, forwarding the transaction data from the transceiver to the server via the wireless data network for obtaining transaction authorization, dropping the clearance to send indication and continuing scanning of the point of sale terminals for a next request to send transaction data.

In still another aspect of the present invention, a system for wirelessly processing transactions from a plurality of point-of-sale terminals using a wireless transaction system, the system includes scanning means for scanning, by the communication transceiver through the communications hub, each point-of-sale terminal for a request to send transaction data, first receiving means for receiving a request to send transaction data from a first point of sale terminal, suspending means for suspending scanning of the remainder of the plurality of point of sale terminals, asserting means for asserting a clearance to the first point of sale terminal for sending the transaction data from the first point of sale terminal to the transceiver, sending means for sending the transaction data from the first point of sale terminal to the transceiver via the communications hub, second receiving means for receiving the transaction data by the transceiver, verifying means for verifying that the transaction data is complete, forwarding means for forwarding the transaction data from the transceiver to the server via the wireless data network for obtaining transaction authorization, dropping means for dropping the clearance to send indication and continuing means for continuing scanning of the point of sale terminals for a next request to send transaction data.

In another aspect of the present invention, a method for wirelessly processing transactions from a plurality of point-of-sale terminals using a wireless transaction system according to any of the previous system aspects of the invention includes scanning, by the communication transceiver, each point-of-sale terminal for a request to send transaction data, the scanning conducted in the sequential order of the ports, receiving a request to send transaction data from a first point of sale terminal, suspending scanning of the remainder of the plurality of point of sale terminals, asserting a clearance to the first point of sale terminal for sending the transaction data from the first point of sale terminal to the transceiver, sending the transaction data from the first point of sale terminal to the transceiver via the communications hub, receiving the transaction data by the transceiver, verifying that the transaction data is complete, forwarding the transaction data from the transceiver to the server via the wireless data network for obtaining transaction authorization, dropping the clearance to send indication, continuing scanning of the point of sale terminals for a next request to send transaction data, receiving a transaction approval from the server via the transceiver and forwarding the transaction approval to the first point of sale terminal via the transceiver for completing the transaction.

The present invention also includes aspects directed to a computer readable medium having computer instructions provided thereon for causing a computer system to perform one or more of the methods outlined in the previous aspects above.

### BRIEF DESCRIPTION OF THE FIGURES

These and other features, aspects and advantages of the present invention will become better understood with regard to the following description and accompanying drawings, flowcharts and screen shots where:

FIG. 1 is a block diagram illustrating an overview of one embodiment of a system for performing wireless transactions according to the present invention. Enabler device according to the present invention.

FIG. 2 is a block diagram illustrating an overview of the Concentrator/Enabler according to one embodiment of the present invention.

FIG. 3 is a flow diagram illustrating an initialization of the Concentrator device according to one embodiment of the present invention.

FIG. 4 is a flow diagram illustrating a main polling loop according to one embodiment of the present invention.

FIG. 5 is a flow diagram illustrating the processing of a Timer Event according to one embodiment of the present invention.

FIG. 6 is a flow diagram illustrating the processing of a Serial Event according to one embodiment of the present invention.

FIG. 7 is a flow diagram illustrating the processing of a Radio Event according to one embodiment of the present invention.

FIG. 8 is a flow diagram illustrating a processing of a transaction (“DoTransaction( ))” function according to one embodiment of the present invention.

FIG. 9 is a flow diagram illustrating a Radio Response (“HandleRFResponse( )) function according to one embodiment of the present invention.

### DETAILED DESCRIPTION OF THE PREFERRED EMBODIMENTS

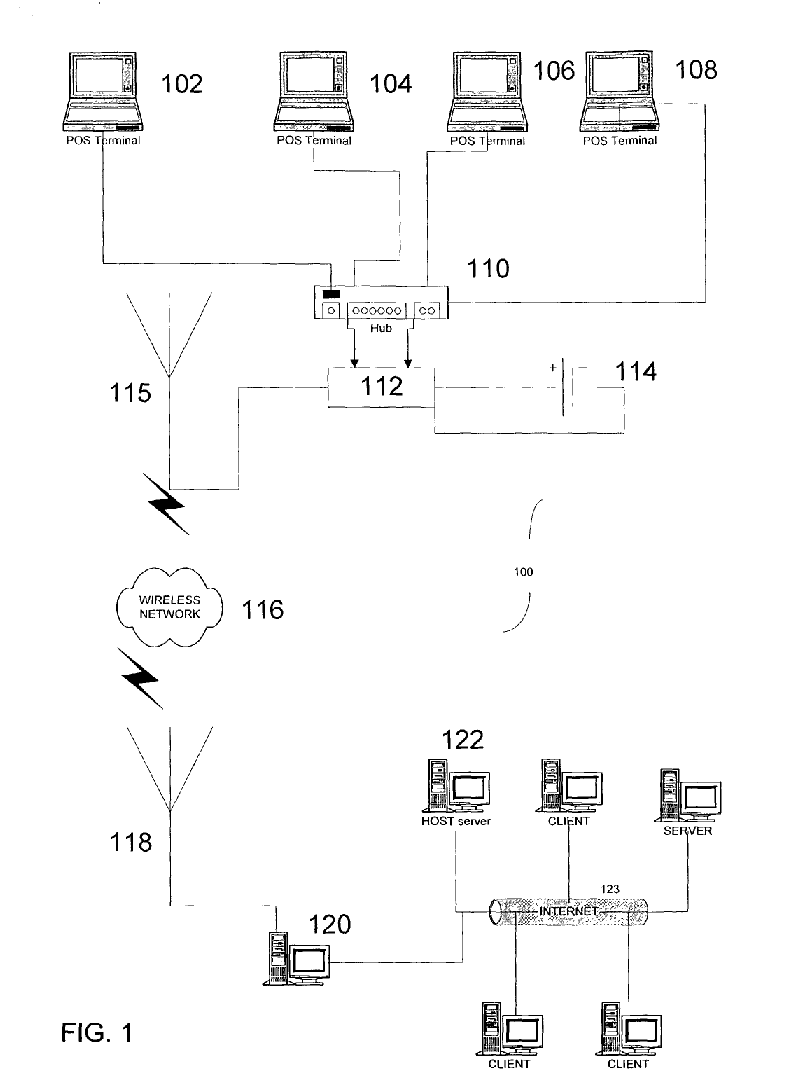

The preferred embodiments of the present invention will now be described in detail with references to FIGS. 1 through 9. Although the systems and methods of the present invention will be described in connection with these preferred embodiments and drawings, it is not intended to be limited to the specific form set forth herein, but on the contrary, it is intended to cover such alternatives, modifications, and equivalents, as can be reasonably included within the spirit and scope of the invention.

The present invention may be used to communicate information between a remote computer and a point-of-sale device. Such point-of-sale devices include cashier registers in retail establishments (grocery stores, restaurants, clothing stores and the like, also, vending machines, taxi meters, jukeboxes, Kiosks (in general), and the like).

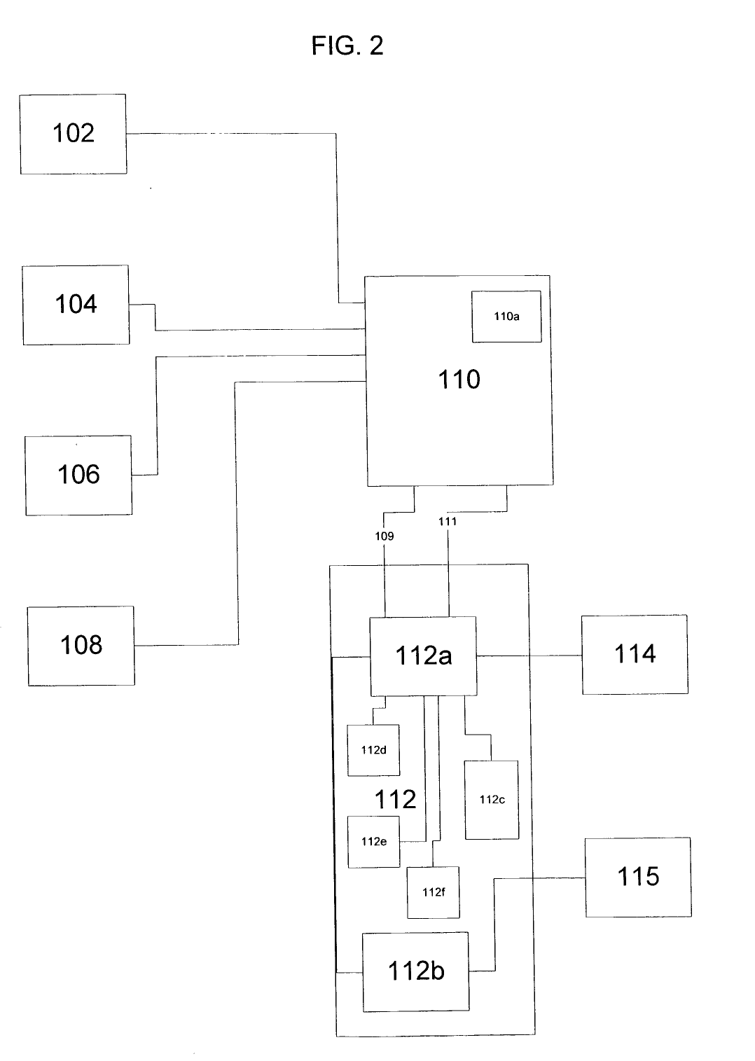

FIGS. 1 and 2 illustrate an embodiment of the invention showing a system block diagram for performing the processes according to the present invention. Accordingly, the system 100 preferably includes a plurality of Point-Of-Sale (POS) terminals 102, 104, 106 and 108, which are in communication with the Concentrator 110 of the present invention via corresponding channels. The POS terminals are connected according to any method including wired and wireless connections. An exemplary connection between the POS terminals and the Concentrator in the present invention includes a cable and RJ45 connections.

The concentrator may also include channel indicators 110c, which visually (or through sound or other sensing) indicate which POS terminal is being scanned for activity, or which channel is currently sending or receiving a credit approval. Such indicators may be LED lights which are illuminated and visible from a front/rear/side of the Concentrator device.

The Concentrator 110 is connected to a transceiver (Enabler) 112 which controls the Concentrator 110 and supplies power thereto. The transceiver is similar to and may include the Enabler device disclosed in commonly assigned U.S. patent application Ser. No. 10/059,939, filed Jan. 29, 2002, the entire disclosure of which is herein incorporated by reference.

Connection between the Concentrator 110 and the Enabler 112 includes a serial connection 109, generally used to pass data between the Concentrator and the Enabler, and a control connection, which controls the various processes carried out by the Concentrator.

The Enabler generally includes a micro-processor 112a, which is in communication with a power source 114 (battery or other DC device, preferably), a memory 112c which may include at least one of a read-only-memory (ROM), a random access memory (RAM), but preferably includes both. The RAM memory may be used as a serial buffer memory 112e, a specific allotment of memory given to each channel. The serial buffer memory temporarily stores data from each channel for going to and coming from a wireless data transceiver 222, and may also be a separate memory from other RAM memories provided in the Enabler. The serial buffer memory may also be provided in the Concentrator. The wireless data transceiver 222 (preferably digital) is for wireless communication with a wireless data network 116. The transceiver is connected to an antenna 115.

The RAM memory may also be used for a response buffer memory 112f, which temporarily stores data going to and coming from the POS terminals. As with the serial buffer memory, this memory may be a memory separate from the Enabler RAM, and may also be provided in the Concentrator as well.

The Enabler may also include other equipment including indicators 112d, for indicating such things as power, wireless signal strength, transmitting data, receiving data, and the like.

Transactional data is sent and received along a wireless network 116, to a Host server 122, located on the internet 123 (for example). The data is received by the wireless network provider having a communications equipment 120 for receiving the transactional data using an antenna 118, which takes the information and routes it to the Host server.

The system operates to send transactional information for point-of-sale purchases from a plurality of POS terminals, which includes (generally) a request of credit/debit/ebt approval from a credit/debit/ebt institution, wirelessly using a single transceiver/controller (Enabler), using a communications multiplexer/hub (the Concentrator).

In an embodiment of the present invention, the concentrator scans each channel which is connected to a corresponding POS terminal. When the Concentrator is connected to the Enabler, and the Enabler and POS terminals are switched on, the port-status indicators cycle continuously. This indicates that the device is functioning properly and is scanning the channels at a predetermined rate (e.g., 10 milliseconds).

The Enabler, via the Concentrator, scans the channels sequentially (preferably, but may scan in other orders) in ascending order (regardless of if a POS terminal is connected to each of the ports), at the predetermined rate. After checking the last channel, it returns to the first port and continues the scanning process.

When the Enabler encounters a port where the POS terminal has raised Request to Send (e.g., for obtaining a credit approval), it stops scanning, the indicator for that particular channel becomes steady and the Enabler asserts a Clear to Send to the POS terminal. When the terminal senses the assertion of Clear to Send, it sends the transaction approval request message to the Enabler. After receiving the message and verifying that it is complete, the Enabler sends the packet over the wireless network to a HOST, which obtains the transaction approval (or disapproval—hereinafter both approval and disapproval will be known as “transaction approval”). During the same time, the Enabler drops Clear to Send, and immediately scans the next channel in the sequence, and continues the scanning process in ascending order. The amount of time from the point when the Enabler recognizes a Request to Send has been raised by a terminal until it resumes the scanning process is typically less than five seconds, and preferably is less than 2 seconds. If two POS terminals raise Request to Send simultaneously, the Enabler may process these requests sequentially in the order in which it encounters them in the channel/port scanning process (or any other manner typical of the art).

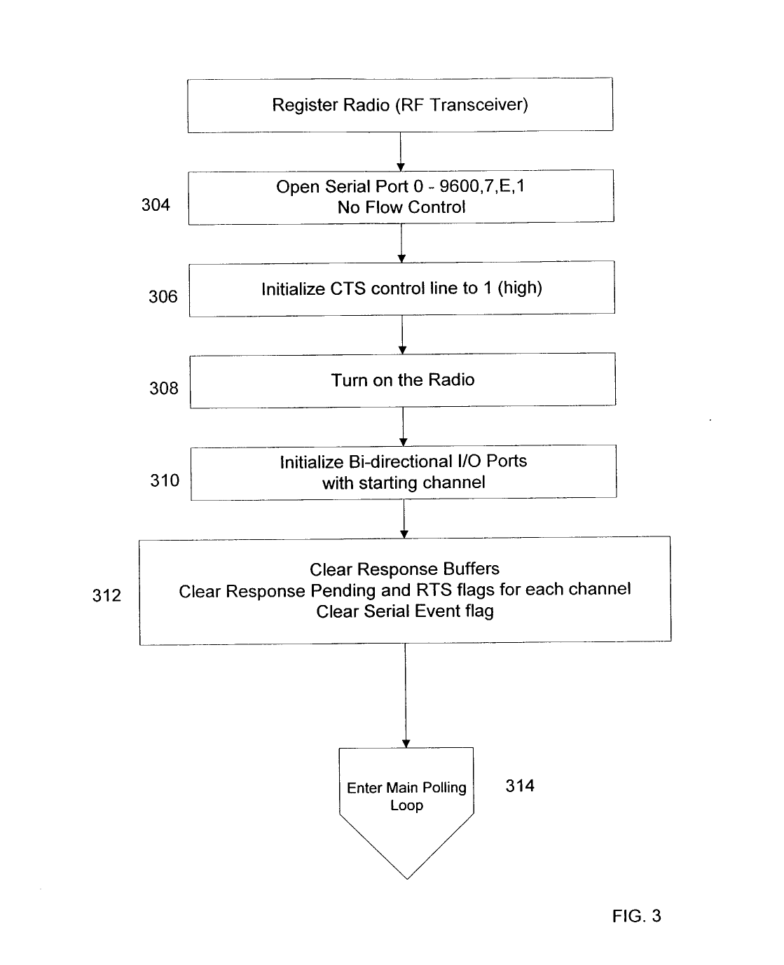

Accordingly, the Concentrator operates according to the process outlined in the flow diagrams shown in FIGS. 3-9. Initially, the RF (radio) transceiver registers with the corresponding data network. This process is shown in FIG. 3. Accordingly, when the Enabler is switched on, power is supplied to the Concentrator which is initialized. The Enabler opens the serial port for communication with the Concentrator according to predetermined settings (e.g., 9600 bits per second, data bits equal to 7, parity set to even, stop bits at 1, with no flow control, for example)(304). The CTS (Clear To Send) control line is then initialized and set to 1 (high)(306). The transceiver is then turned on (308). The bi-directional input/output ports are initialized, with the first (starting) channel (310). At that time, the response memory buffers are cleared, as are pending responses and RTS (Request to Send) flags for each channel; the serial event flag is cleared (312). Main polling of the terminals is then initiated (314).

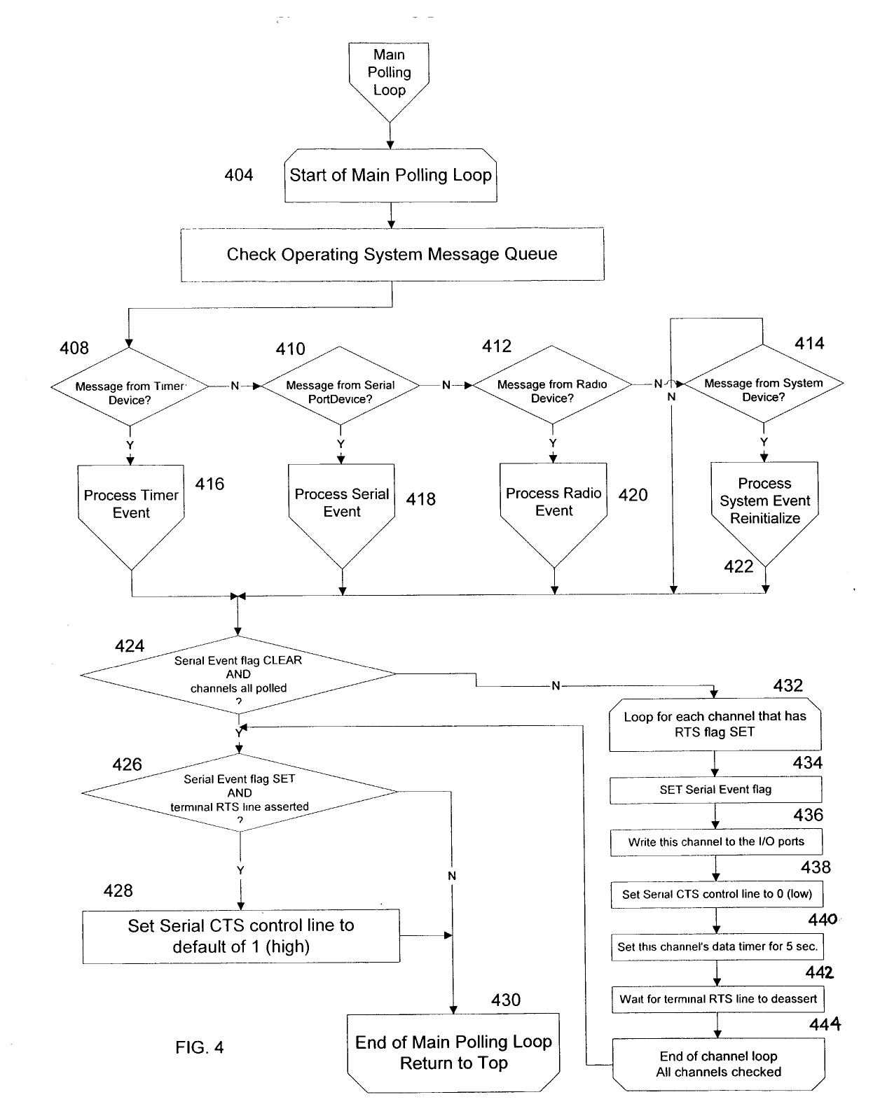

FIG. 4 illustrates the main polling of the POS terminals. Accordingly, an event message queue of the system is checked to determine if there are any event flags for processing. Such event messages may come from, for example, the Timer Device, the serial port device, the transceiver and a system device. Event messages may be checked in any order and one skilled in the art will recognize that the order of messages checked as shown in the figure is just one possible order.

Thus, for example, as shown in the Figure, an event message from the Timer Device is processed first (408, 416), then events from the serial port devices (POS terminals)(410, 418), transceiver events (412, 420), and system events (414, 422). If there are no queued events (including, for example, Serial event flag is clear), then a determination is made to determine if the POS terminals (channels) have all been polled (424). Of course, upon initiation of polling, none of the channels have been polled. Steps 432-444 are performed on a channel in which a RTS flag has been set by a channel. Starting with the first channel having an RTS flag set (432), a serial event flag is set (434), and the channel is written to the Input/Output ports (436). Accordingly, the CTS control line is then set to 0 (low)(438). The timer is set for the particular channel to a predetermined period of time (e.g., 5 seconds)(440). The process then waits for the terminal RTS line to de-assert (442). The loop then terminates at step 444.

If the serial event flag is set, and the terminal RTS line is asserted (426), then the serial CTS control line is set to the default condition of 1 (high)(428), and the process returns to the start of the main polling loop (430, 404).

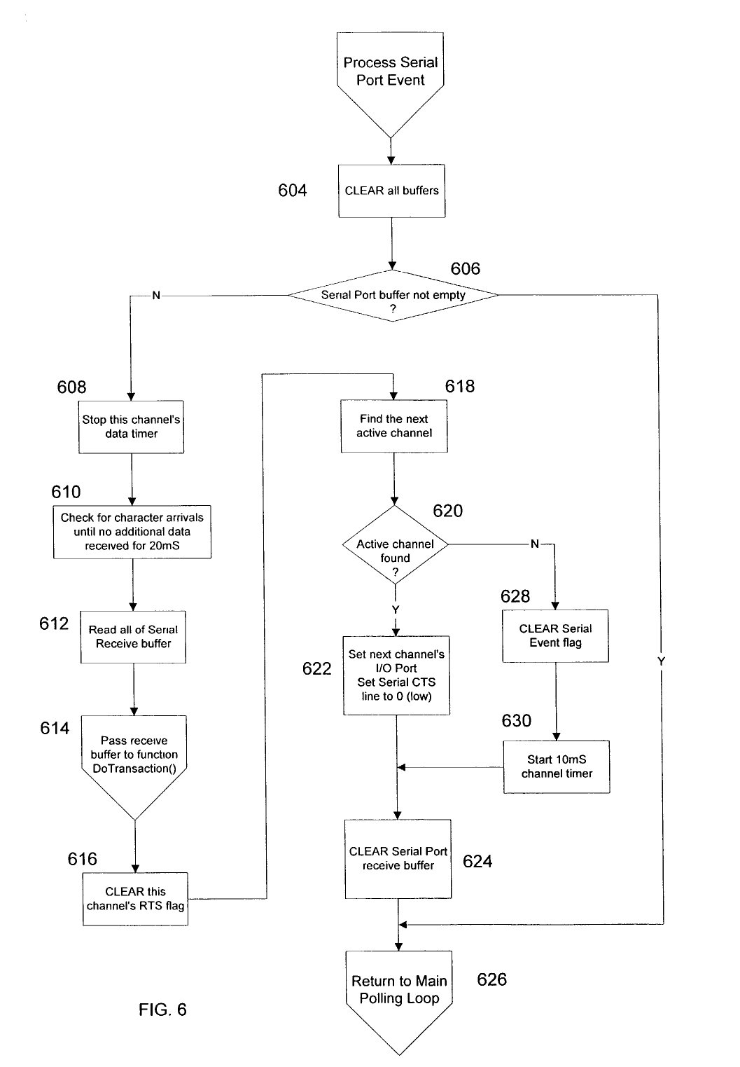

If the serial event flag is set, but the RTS line is de-asserted, or if the serial event flag is not set and the terminal RTS line is asserted or de-asserted, then the process is returned to the start of the main polling loop (430, 404). Accordingly, a serial event flag indicates a serial event, which, upon the process returning to step 404, the serial event is processed (410, 418)(see FIG. 6).

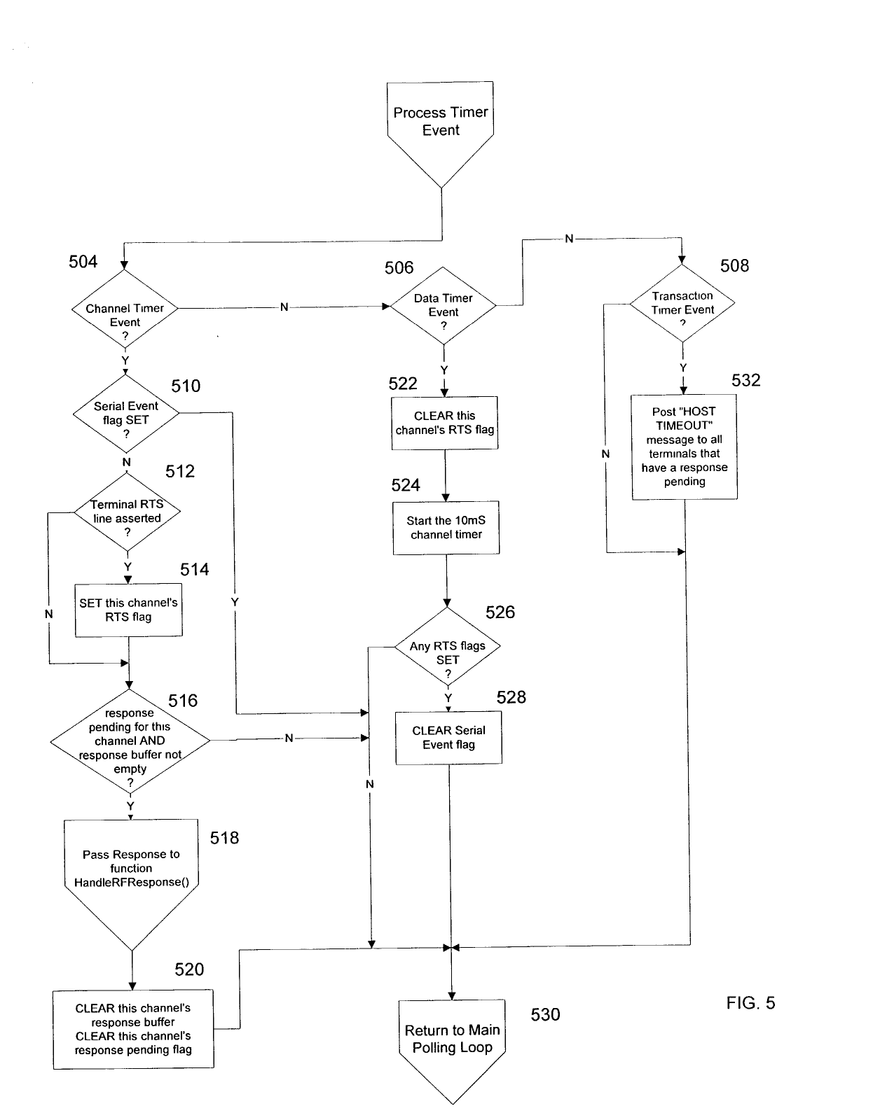

Events are processed in the following manner according to FIGS. 5-9. FIG. 5 illustrates the process in which a timer event is processed for a first (particular) channel, which handles the various events associated with the multiple timers used with the invention. The decision blocks for this flow are implemented preferably as a switch/case statement.

The first pathway of the flow diagram controls the switching rate of the channels (504). Accordingly, it is first determined whether there exists a channel timer event (504). If so, then a determination is made as to whether a Serial Event flag is set (510). If a serial event flag is set and the terminal RTS line is asserted (510, 512), then an RTS flag is set for the first channel (514). If the serial event flag is set, but the terminal line is not asserted, then the process skips over setting the first channel's RTS flag (510, 512). However, if the serial event flag is not set, then the process returns to the main polling loop (510, 530) (FIG. 4).

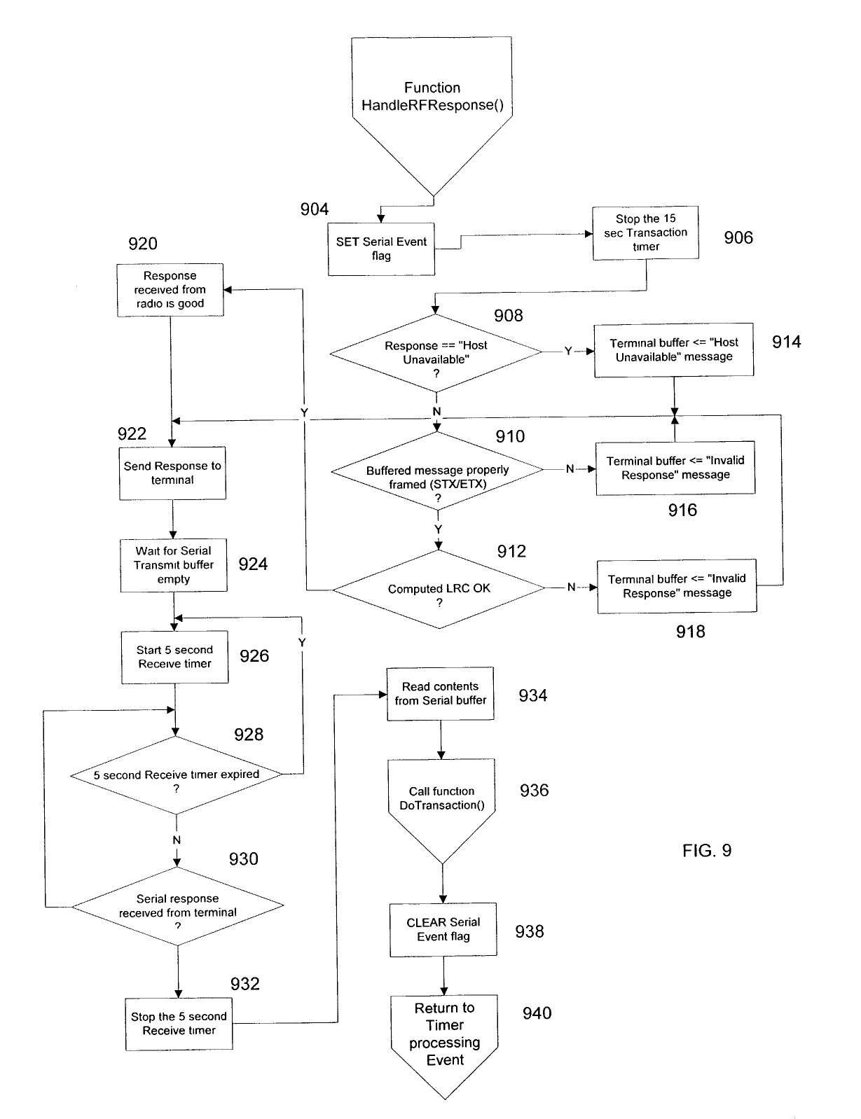

If a response is pending for the first channel and the response buffer is not empty, then the response is passed to the function of HandleRFResponse (516)(see FIG. 9). Thereafter, the response buffer and the response pending flag for the first channel are cleared (520). The process then returns to the main polling loop (530)(FIG. 4). If a response is pending (or not pending), and the response buffer for the first channels is empty, then the process returns to the main polling loop (530) (FIG. 4).

If there is not channel timer event, then a determination is made as to whether there is a data timer event for the first channel (506). A data timer event occurs with an RTS/CTS handshake and no data is sent from the terminals during a predetermined time period (timer). If so, then the first channel's RTS flag is cleared and the channel timer is started to count down a predetermined period of time (for example, 10 milliseconds)(524). It is then determined whether there are any other RTS flags set (526). If so, then the serial event flag is cleared (528) and the process returns to the main polling loop (530). This pathway generally performs as a watchdog timer to insure that no channel is stuck “on”. If there are not RTS flags set, the process simply returns to the main polling loop (526, 530).

If there is no data timer event, then a determination is made as to whether there is a transaction timer event (508). This pathway of the flow diagram is a timer of the response from the host. If there is no transaction timer event, then the process returns to the main polling loop (530). If there is a transaction timer event, then a message “HOST TIMEOUT” is posted to all terminals that have a response pending, and the process returns to the main polling loop (532, 530).

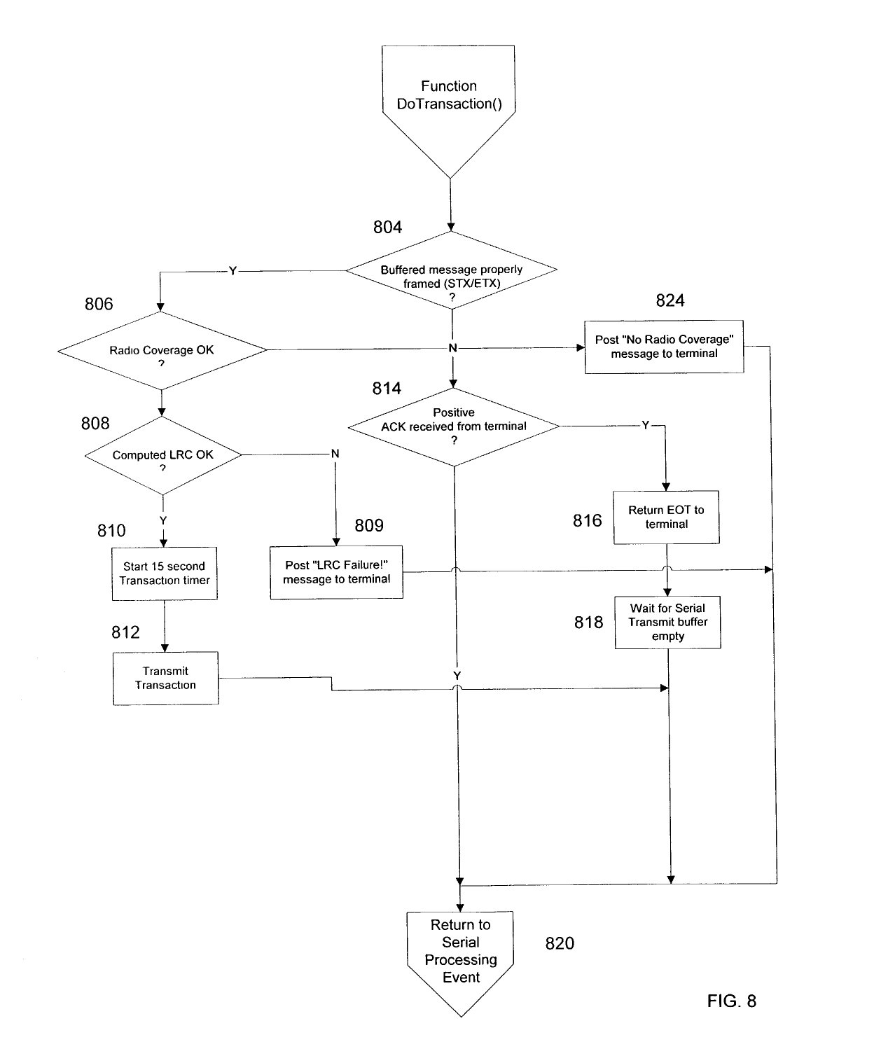

Serial port data receive events are processed according to FIG. 6. Initially, all buffers are cleared (604), at which point, a determination is made as to whether the serial port buffer for a first channel is empty (606). If the serial port buffer is empty, then the process returns to the main polling loop (625. If the serial port buffer is not empty, then the first channel's data time is stopped (608). Character arrivals are checked for until no additional data is received for a particular amount of time (say, for example, 20 milliseconds)(610). Thereafter, all of the data in the serial receive buffer is read and passed to the function “DoTransaction” (612, 614)(see FIG. 8), and the first channel's RTS flag is cleared (616. A search for the next active channel is then conducted (618). When a next active channel is found, then the I/O port for this channels is set, and the serial CTS line is set to 0 (low)(622). Thereafter, the serial port receive buffer is cleared and the process is returned to the main polling loop (624, 626). If an active channel is not found, then the serial event flag is cleared for the first channel and a timer for the first channel is started (620, 628, 630). The serial port receive buffer for the first channel is then cleared and the process returns to the main polling loop (624, 626).

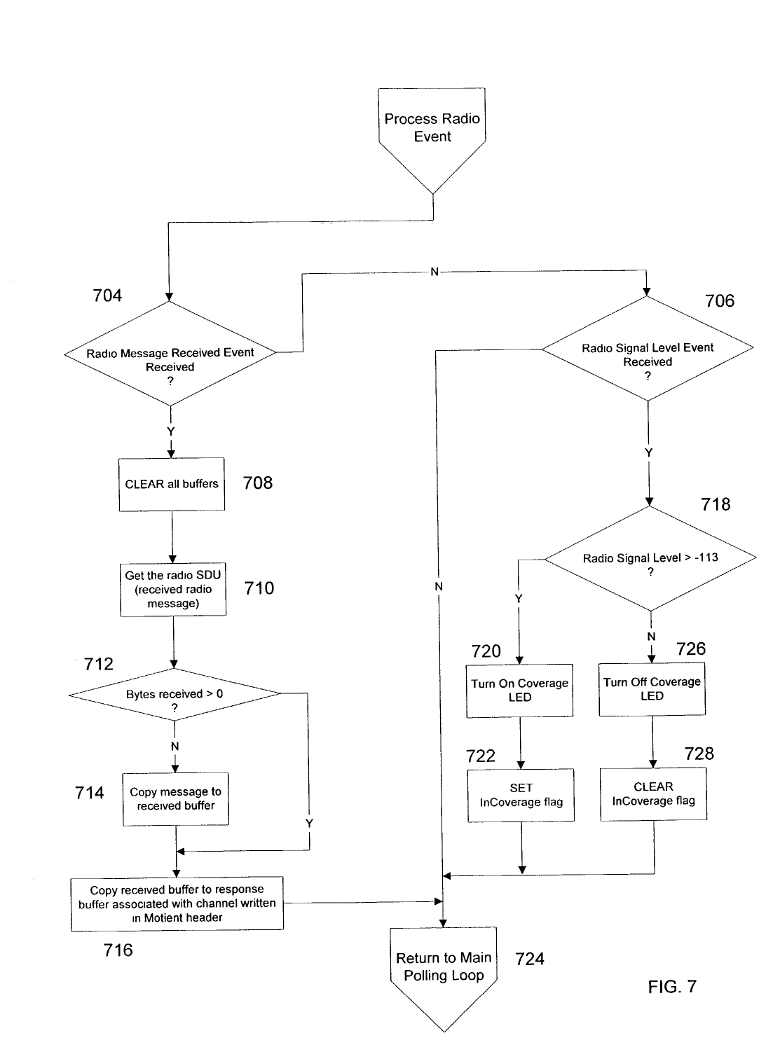

FIG. 7 illustrates the processing of a radio (transceiver) event. Accordingly, a determination is made whether a radio message received event is received (704). Radio messages received are stored according to the channel number embedded in the header of the message. The buffer element for the particular channel preferably holds the message. If a radio message received event is received, then all buffers are cleared, and the message is received in the buffer element for the destined channel (according to the message header)(708, 710). Thereafter, the message is copied from the received buffer to the response buffer (712-716), and the process is returned to the main polling loop (724).

If a radio message received event has not been received (704), then a determination is made as to whether a radio signal level event has been received (706). If not, the process is returned to the main polling loop (724). If so, then the strength of the radio signal is determined (718). If the radio signal is less than a predetermined level (for example, −113), then a coverage-LED is turned off (718, 726), an InCoverage flag is cleared (722), and the process is returned to the main polling loop (724). If the radio signal strength is greater then the predetermined amount (718), then the coverage-LED is turned on (720), the InCoverage flag is set (722), and the process returned to the main polling loop (724). The radio signal level messages are generally used to determine coverage. The coverage-LED may include a series of bar shaped LEDs, each subsequent LED being taller/bigger than the previous LED. A strong radio signal would turn on all LEDs, for example, and a weaker signal would turn on only a limited number of LEDs.

FIG. 8 illustrates the process flow of the “DoTransaction” function. This function takes the terminal's message buffer and transmits it to the Host. Acknowledgement (ACK) and negative acknowledgements are handled in this process as well. Initially, a determination is made as to whether the buffered message is properly framed (STX/ETX)(804). If not, then a determination is made as to whether an acknowledgement is received from the terminal (814). If an acknowledgement exists and it is a negative acknowledgement, then the process returns to the Serial Event Processing flow (822) of FIG. 6 (822). If the acknowledgement is a positive acknowledgement, then an “End of Transmission” message is returned to the POS terminal, the serial transmit buffered is emptied (814, 816, 818, 822). The process then is returned to the Serial Processing Event flow (822).

However, if the buffered message is properly framed, then the radio coverage is checked (806). If the radio coverage is inadequate, then the message “No Radio Coverage” is sent to the POS terminal (824). If radio coverage is adequate, then an LRC (longitudinal redundancy check) is performed (808). LRC is system of error control based on the formation of a block check according to predetermined rules. If the LRC is inadequate, then the message “LRC Failure” is returned to the POS terminal, and the process returns to Serial Processing Event flow (808, 809, 822).

If the LRC is successful, then a transaction timer is initiated (say, for example, for 15 seconds) and the transaction is transmitted (808, 810, 812). Thereafter, the process returns to the Serial Processing Event flow(822).

FIG. 9 illustrates the “HandleRFResponse” function. This function handles the response from the HOST and determines the proper channel to respond to the terminal. Initially, the Serial event flag is set and the transaction timer is stopped (904, 906). If the Host is available (908), the buffered message is properly framed (910) and the Longitudinal Redundancy Check (LRC) is satisfactory (912), then the response from the radio is sent to the POS terminal (920, 922). When the serial transmit buffer is then empty from sending the response to the POS terminal (924), then a receiver timer is started (say, for example, 5 seconds), at which time a serial response is sent from the POS terminal (926). When the response has been completely received from the POS terminal (926-930), the timer is stopped (932), the contents of the serial buffer are read (934), and the function “DoTransaction” (FIG. 8) is performed (936). Thereafter, the Serial event flag is cleared (938) and the process returns to the Timer Processing Event (940) (FIG. 5).

If the Host is unavailable (908), then a “HOST Unavailable” message is forwarded to the POS Terminal (914). Similarly, if the buffered message is not properly framed, or the LRC is unsuccessful, the message “Invalid response” is forwarded to the POS terminal (910, 916, 912, 918). After each of these message are forwarded to the POS terminal, and process continues from steps 920-940.

Having described the invention with reference to the presently preferred embodiments, it should be understood that numerous changes in creating and operating such systems and methods may be introduced without departing from the true spirit of the invention as defined in the appended claims.

What is claimed is:

1. A system for processing transactions for a plurality of point-of-sale terminals wirelessly comprising:
a plurality of point-of-sale terminals;
a communications hub in communication with each of the plurality of point of sale terminals; and
a communications device in communication with the communications hub, the communications device for communicating data to and from a wireless network for at least two point of sale terminals.

2. The system according to claim 1, wherein the plurality of point-of-sale terminals each include a first communication port.

3. The system according to claim 2, wherein the communications hub includes a plurality of second communication ports for connection with a corresponding first communication port of the plurality of point of sale terminals, a control port, a data port, and a status indicator for each of the second communication ports.

4. The system according to claim 3, wherein the communications device comprises a wireless data transceiver, a controller, a control port for connection with the control port of the hub, a data port for connection with the data port of the hub, a power supply and an antenna, wherein the transceiver communicates transaction data over the wireless network to a server provided on a computer network for at least two point of sale terminals.

5. The system according to claim 3, wherein upon a request for sending transaction data from a particular point of sale terminal, the corresponding status indicator indicates communication from the particular point of sale terminal.

6. The system according to claim 4, wherein the data ports each comprises an RS-232 port.

7. The system according to claim 4, wherein the control ports each comprises RS-232 port.

8. The system according to claim 2, wherein the first communication port comprises an RJ45 port.

9. The system according to claim 1, wherein data transfer between the point of sale terminals, the communications hub and the communications device is via RS232 protocol.

10. The system according to claim 3, wherein the first communication port and the second communication port each comprises an 8 pin port.

11. The system according to claim 4, wherein the data ports each comprises a 9-pin port.

12. The system according to claim 4, wherein the control ports comprise a 9-pin port.

13. The system according to claim 4, wherein flow control of the data ports through the hub to the POS terminals are via RTS or CTS.

14. A system for processing transactions for a plurality of point-of-sale terminals wirelessly comprising:
a wireless data network for communicating data between a remote device and a server on a computer network;
a plurality of point-of-sale terminals;
a communications hub in communication with each of the plurality of point of sale terminals; and
a wireless data network transceiver in communication with the communications hub, the transceiver for communicating data to and from the server via the wireless network for at least two point of sale terminals.

15. A system for wirelessly processing transactions from a plurality of point-of-sale terminals comprising:
a plurality of point-of-sale terminals each having a first communication port;
a communications hub having a corresponding second communication port for connection with each first communication port of the plurality of point of sale terminals, a control port, a data port, and a status indicator for each of the second communication ports; and
a communications device including a controller, a wireless data network transceiver, a control port for connection with the control port of the hub, a data port for connection with the data port of the hub, a power supply and an antenna, wherein the transceiver communicates transaction data over a wireless network to a server provided on a computer network for at least two point of sale terminals.

16. A method for wirelessly processing transactions from a plurality of point-of-sale terminals using a wireless transaction system, the system including:
a wireless data network for communicating data between a remote device and a server on a computer network;
a plurality of point-of-sale terminals;
a communications hub in communication with each of the plurality of point of sale terminals; and
a communications device in communication with the communications hub, the communication device having a transceiver for communicating data to and from the server via the wireless network for at least two point of sale terminals.
the method comprising:
scanning by the communications device via the communication hub each point-of-sale terminal for a request to send transaction data;
receiving a request to send transaction data from a first point of sale terminal;
suspending scanning of the remainder of the plurality of point of sale terminals;
asserting a clearance for sending the transaction data from the first point of sale terminal to the transceiver;
sending the transaction data from the first point of sale terminal to the transceiver via the communications hub;
receiving the transaction data by the transceiver;
verifying that the transaction data is complete;
forwarding the transaction data from the transceiver to the server via the wireless data network for obtaining transaction authorization;
dropping the clearance to send indication; and
continuing scanning of the point of sale terminals for a next request to send transaction data.

17. The method according to claim 16, wherein the plurality of point of sale terminals are connected to the communication hub via a plurality of ports, each port corresponding to a particular point of sale terminal, and wherein the plurality of ports are scanned in a predetermined order.

18. The method according to claim 17, wherein the plurality of ports are sequentially numbered, and wherein the predetermined order comprises a sequential order.

19. The method according to claim 17, further comprising the transceiver receiving a transaction approval from the server, forwarding the transaction approval from the transceiver to the first point of sale terminal for completing the transaction.

20. The method according to claim 19, wherein, upon the transceiver receiving the transaction approval during a time in which the transceiver is forwarding second transaction data from another point of sale terminal to the server, the transaction approval is temporality stored in a buffer, and wherein the transaction approval is forwarded to the first point of sale terminal after the second transaction data has been forwarded by the transceiver to the server.

21. A system for wirelessly processing transactions from a plurality of point-of-sale terminals using a wireless transaction system, the system comprising:
scanning means for scanning each point-of-sale terminal for a request to send transaction data;
first receiving means for receiving a request to send transaction data from a first point of sale terminal;
suspending means for suspending scanning of the remainder of the plurality of point of sale terminals;
asserting means for asserting a clearance to the first point of sale terminal for sending the transaction data from the first point of sale terminal to a transceiver;
sending means for sending the transaction data from the first point of sale terminal to the transceiver via a communications hub;
second receiving means for receiving the transaction data by the transceiver;
verifying means for verifying that the transaction data is complete;
forwarding means for forwarding the transaction data from the transceiver to the server via the wireless data network for obtaining transaction authorization;
dropping means for dropping the clearance to send indication; and
continuing means for continuing scanning of the point of sale terminals for a next request to send transaction data.

22. The system according to claim 21, wherein the first receiving means and the second receiving means comprise a common receiving means.

23. A method for wirelessly processing transactions from a plurality of point-of-sale terminals using a wireless transaction system, the system including:
a wireless data network for communicating data between a remote device and a server on a computer network;
a plurality of point-of-sale terminals;
a communications hub in communication with each of the plurality of point of sale terminals via a plurality corresponding ports, wherein the ports are arranged in a sequential order; and
a wireless data network transceiver in communication with the communications hub, the transceiver for communicating data to and from the server via the wireless network for at least two point of sale terminals.
the method comprising:
scanning, by the communications device via the communication hub, each point-of-sale terminal for a request to send transaction data, the scanning conducted in the sequential order of the ports;
receiving a request to send transaction data from a first point of sale terminal;
suspending scanning of the remainder of the plurality of point of sale terminals;
asserting a clearance to the first point of sale terminal for sending the transaction data from the first point of sale terminal to the transceiver;
sending the transaction data from the first point of sale terminal to the transceiver via the communications hub;
receiving the transaction data by the transceiver;
verifying that the transaction data is complete;
forwarding the transaction data from the transceiver to the server via the wireless data network for obtaining transaction authorization;
dropping the clearance to send indication;
continuing scanning of the point of sale terminals for a next request to send transaction data;
receiving a transaction approval from the server via the transceiver; and
forwarding the transaction approval to the first point of sale terminal via the transceiver for completing the transaction.

24. A computer readable medium having computer instructions provided thereon for causing a computer system to perform a method for wirelessly processing transactions from a plurality of point-of-sale terminals using a wireless transaction system, the system including:
a wireless data network for communicating data between a remote device and a server on a computer network;
a plurality of point-of-sale terminals;
a communications hub in communication with each of the plurality of point of sale terminals; and
a wireless data network transceiver in communication with the communications hub, the transceiver for communicating data to and from the server via the wireless network for at least two point of sale terminals.
the method comprising:
scanning by the communications device via the communication hub each point-of-sale terminal for a request to send transaction data;
receiving a request to send transaction data from a first point of sale terminal;
suspending scanning of the remainder of the plurality of point of sale terminals;
asserting a clearance to the first point of sale terminal for sending the transaction data from the first point of sale terminal to the transceiver;
sending the transaction data from the first point of sale terminal to the transceiver via the communications hub;
receiving the transaction data by the transceiver;
verifying that the transaction data is complete;
forwarding the transaction data from the transceiver to the server via the wireless data network for obtaining transaction authorization;
dropping the clearance to send indication; and
continuing scanning of the point of sale terminals for a next request to send transaction data.
